(19) United States
(12) Patent Application Publication
(10) Pub. No.: US 2025/0092316 A1
(43) Pub. Date: Mar. 20, 2025

(54) REFINING METHOD AND DEVICE OF WASTE PLASTIC PYROLYSIS OIL

(71) Applicants: SK INNOVATION CO., LTD., Seoul (KR); SK GEO CENTRIC CO., LTD., Seoul (KR)

(72) Inventors: Heejung JEON, Daejeon (KR); Kayoung KIM, Daejeon (KR); Okyoun KIM, Daejeon (KR); Youngmoo PARK, Daejeon (KR); Seung Woo LEE, Daejeon (KR)

(21) Appl. No.: 18/841,680

(22) PCT Filed: Mar. 7, 2023
(86) PCT No.: PCT/KR2023/003122

§ 371 Date: Aug. 27, 2024

(30) Foreign Application Priority Data
Mar. 7, 2022 (KR) 10-2022-0028535

(51) Int. Cl. C10G 1/10; C10G 67/04; C10G 67/14

(52) U.S. Cl. CPC C10G 1/10; C10G 67/04; C10G 67/14; C10G 2300/1003; C10G 2300/4006; C10G 2300/4012; C10G 2300/4018; C10G 2300/44

(57) ABSTRACT

The present disclosure provides a method for refining waste plastic pyrolysis oil, the method including: a first step of mixing a dechlorinating solution containing a polar aprotic solvent and water and waste plastic pyrolysis oil to form a mixed oil; a second step of allowing the mixed oil in the first step to stand and separating the dechlorinating solution located at a lower portion to obtain pre-treated waste plastic pyrolysis oil; a third step of performing a dechlorination reaction by hydrotreating the pre-treated waste plastic pyrolysis oil in the second step at a first temperature in the presence of a hydrotreating catalyst; and a fourth step of performing a denitrification reaction by hydrotreating a product produced in the third step at a second temperature in the presence of a hydrotreating catalyst.

### CROSS-REFERENCE TO RELATED APPLICATIONS

This application is a national stage application of PCT/KR2023/003122 filed on Mar. 7, 2023, which claims priority of Korean patent application number 10-2022-0028535 filed on Mar. 7, 2022. The disclosure of each of the foregoing applications is incorporated herein by reference in its entirety.

### BACKGROUND

### Technical Field

Embodiments of the present disclosure relate to a method and device for refining waste plastic pyrolysis oil.

### Related Art

Waste plastics, which are produced using petroleum as a raw material, are not recyclable and are mostly disposed of as garbage. These wastes take a long time to degrade in nature, which causes contamination of the soil and serious environmental pollution. As a method for recycling waste plastics, there is a method for pyrolyzing and converting waste plastics into usable oil, and the obtained oil is called waste plastic pyrolysis oil.

However, pyrolysis oil obtained by pyrolysis of waste plastics cannot be immediately used as a high-value-added fuel such as gasoline or diesel oil because it has a higher content of impurities such as chlorine, nitrogen, and metals than fractions produced from crude oil by a general method, and therefore, pyrolysis oil needs to go through a refinery process.

As a refinery process according to the related art, a process of hydrotreating waste plastic pyrolysis oil in the presence of a hydrotreating catalyst to remove chlorine, nitrogen, and other metal impurities has been performed. However, waste plastic pyrolysis oil containing a high content of impurities needs to be hydrotreated under severe conditions due to its characteristics, and in particular, when the waste plastic pyrolysis oil is hydrotreated at 450° C. or higher, there are issues such as a reduction in reaction yield due to occurrence of side reactions such as deactivation of a catalyst and cracking. In addition, an excessive amount of HCl is produced due to a high content of chlorine impurities contained in the waste plastic pyrolysis oil, which causes equipment corrosion, an abnormal reaction, and deterioration of product properties. In particular, HCl reacts with a nitrogen compound to form an ammonium salt (NH₄Cl), and the ammonium salt causes corrosion of a reactor, which causes not only a reduction in durability but also various process complications such as a differential pressure and a reduction in process efficiency.

In order to reduce a content of chlorine in pyrolysis oil to a level that allows pyrolysis oil to be introduced into the refinery process, a pre-treatment process such as a cleaning process or a water treatment process has been performed, but this process has a limitation in that inorganic chlorine in the pyrolysis oil is mainly removed but most organic chlorine is not removed. As another example of the pre-treatment process, a process of removing impurities such as chlorine, nitrogen, and sulfur by a neutralization process using basic substances such as KOH and NaOH has been performed. However, such a neutralization and removal process has limitations in that equipment corrosion is caused, resulting in issues such as an abnormal reaction and a reduction in process efficiency, and chlorine removal efficiency is not high, which makes it difficult to reduce a content of chlorine to a level that allows the pyrolysis oil to be introduced into the refinery process.

Accordingly, there is a demand for a method and device for refining waste plastic pyrolysis oil that may minimize issues such as a differential pressure, equipment corrosion, an abnormal reaction, and deterioration of product properties in a refinery process of waste plastic pyrolysis oil containing a high content of chlorine.

### SUMMARY

Embodiments of the present disclosure provide a method and device for refining waste plastic pyrolysis oil that may implement a stable operation of a refinery process for a long period of time by minimizing formation of an ammonium salt (NH₄Cl) in the refinery process in conjunction with a pre-treatment process and a hydrotreating process of the waste plastic pyrolysis oil.

Embodiments of the present disclosure provide a method and device for refining waste plastic pyrolysis oil by which waste plastic pyrolysis oil having significantly low contents of impurities such as chlorine, nitrogen, and metals, and olefins may be obtained with a high yield without a change in molecular weight distribution.

In an embodiment, a method for refining waste plastic pyrolysis oil includes a first operation of mixing a dechlorinating solution containing a polar aprotic solvent and water and waste plastic pyrolysis oil to form a mixed oil; a second operation of allowing the mixed oil in the first operation to stand and separating the dechlorinating solution located at a lower portion to obtain pre-treated waste plastic pyrolysis oil; a third operation of performing a dechlorination reaction by hydrotreating the pre-treated waste plastic pyrolysis oil in the second operation at a first temperature in the presence of a hydrotreating catalyst; and a fourth operation of performing a denitrification reaction by hydrotreating a product produced in the third operation at a second temperature in the presence of a hydrotreating catalyst.

In an embodiment, in the first operation, the dechlorinating solution and the waste plastic pyrolysis oil may be stirred at a temperature of 60 to 300° C.

In an embodiment, the polar aprotic solvent may have a dielectric constant of 20 or more and a density of 0.9 g/cc or more.

In an embodiment, the polar aprotic solvent may contain dimethylformamide (DMF) or dimethyl sulfoxide (DMSO).

In an embodiment, a difference in density between the dechlorinating solution and the waste plastic pyrolysis oil may be 0.3 g/cc or more.

In an embodiment, the dechlorinating solution may be contained in an amount of 0.1 to 20 parts by weight based on 100 parts by weight of the waste plastic pyrolysis oil.

In an embodiment, a weight ratio of the polar aprotic solvent to the water may be 50:50 to 95:5.

In an embodiment, the method may further include a fifth operation of separating the polar aprotic solvent from the dechlorinating solution recovered in the second operation and resupplying the separated polar aprotic solvent to the first operation.

In an embodiment, the fifth operation may include: a 5-1st operation of distilling the dechlorinating solution to separate the water and recovering a residual solution; a 5-2nd operation of filtering the residual solution to separate a chlorine-containing salt from the residual solution and recovering the polar aprotic solvent; and a 5-3rd operation of resupplying the recovered polar aprotic solvent as the polar aprotic solvent in the first operation.

In an embodiment, the first temperature may be 100 to 300° C., and the second temperature may be 300 to 450° C.

In an embodiment, the hydrotreating catalyst in each of the third operation and the fourth operation may be a catalyst in which an active metal including one or two or more selected from molybdenum, nickel, cobalt, and tungsten is supported on a support.

In an embodiment, a reaction pressure in the hydrotreating in each of the third operation and the fourth operation may be less than 100 bar.

In an embodiment, a ratio of liquid hourly space velocities (LHSVs) in the hydrotreating in the third operation and the hydrotreating in the fourth operation may be 1:0.1 to 1:0.8.

In an embodiment, the method may further include, between the third operation and the fourth operation, an operation of performing a dechlorination process by mixing the product produced in the third operation and a dechlorinating solution containing a polar aprotic solvent and water.

In another embodiment, a device for refining waste plastic pyrolysis oil includes a first reactor into which a dechlorinating solution containing a polar aprotic solvent and water and waste plastic pyrolysis oil are introduced and in which a pre-treatment process is performed; a second reactor into which a product produced in the first reactor and hydrogen gas are introduced and in which a dechlorination reaction is performed by hydrotreating the product at a first temperature in the presence of a hydrotreating catalyst; and a third reactor into which a product produced in the second reactor and hydrogen gas are introduced and in which a denitrification reaction is performed by hydrotreating the product at a second temperature in the presence of a hydrotreating catalyst.

In an embodiment, the first reactor may be a batch reactor.

In an embodiment, the second reactor and the third reactor may be fixed bed reactors.

In addition, the device may further include a recovery tank that recovers the dechlorinating solution discharged from the first reactor and includes a distillation zone and a filtration zone; and a recirculation line that resupplies the polar aprotic solvent separated from the recovery tank to the first reactor.

In the method and device for refining waste plastic pyrolysis oil according to the embodiments of the present disclosure, formation of an ammonium salt (NH₄Cl) may be suppressed or minimized when a pre-treatment process and a hydrotreating process, which is a refinery process, of the waste plastic pyrolysis oil are performed in conjunction with each other, such that the refinery process may be stably performed for a long period of time.

In the method and device for refining waste plastic pyrolysis oil according to the embodiments of the present disclosure, organic chlorine and inorganic chlorine remaining in the waste plastic pyrolysis oil may be simultaneously and effectively reduced.

In the method and device for refining waste plastic pyrolysis oil according to the embodiments of the present disclosure, the hydrotreating process is performed in two stages at different temperatures, such that formation of an ammonium salt (NH₄Cl) may be suppressed or minimized, thereby stably performing the refinery process for a long period of time.

In the method and device for refining waste plastic pyrolysis oil according to the embodiments of the present disclosure, it is possible to provide waste plastic pyrolysis oil having significantly low contents of impurities such as chlorine, nitrogen, and metals, and olefins with a high yield without a change in molecular weight distribution.

### DETAILED DESCRIPTION

Unless otherwise defined, all technical terms and scientific terms used in the present specification have the same meanings as commonly understood by those skilled in the art to which the present disclosure pertains. The description for the known function and configuration unnecessarily obscuring the gist of the present disclosure will be omitted in the following description and the accompanying drawings.

Unless the context clearly indicates otherwise, the singular forms of the terms used in the present specification may be interpreted as including the plural forms.

A numerical range used in the present specification includes upper and lower limits and all values within these limits, increments logically derived from a form and span of a defined range, all double limited values, and all possible combinations of the upper and lower limits in the numerical range defined in different forms. Unless otherwise specifically defined in the present specification, values out of the numerical ranges that may occur due to experimental errors or rounded values also fall within the defined numerical ranges.

The expression “comprise(s)” described in the present specification is intended to be an open-ended transitional phrase having an equivalent meaning to “include(s)”, “contain(s)”, “have (has)”, or “are (is) characterized by”, and does not exclude elements, materials, or operations, all of which are not further recited herein.

Unless otherwise defined, a unit of “%” used in the present specification refers to “wt %”.

Unless otherwise defined, a unit of “ppm” used in the present specification refers to “mass ppm”.

A boiling point used in the present specification unless specifically mentioned otherwise refers to a boiling point at 1 atm and 25° C.

A density used in the present specification unless specifically mentioned otherwise refers to a density at 1 atm and 25° C.

Pyrolysis oil obtained by pyrolysis of waste plastics cannot be immediately used as a high-value-added fuel such as gasoline or diesel oil because it has a higher content of impurities such as chlorine, nitrogen, and metals than fractions produced from crude oil by a general method, and therefore, pyrolysis oil needs to go through a refinery process.

As the refinery process, a method for removing chlorine by converting the chlorine into HCl by hydrotreating waste plastic pyrolysis oil in the presence of a hydrotreating catalyst has been performed. However, since waste plastic pyrolysis oil contains a high content of chlorine, an excessive amount of HCl is produced during hydrotreating, which causes equipment corrosion, an abnormal reaction, and deterioration of product properties. In addition, HCl reacts with a nitrogen compound to form an ammonium salt (NH₄Cl) during the refinery process, and the ammonium salt causes corrosion of a reactor, which causes not only a reduction in durability but also various process complications such as a differential pressure and a reduction in process efficiency.

Accordingly, the embodiments of the present disclosure provide a method for refining waste plastic pyrolysis oil, the method including a first operation of mixing a dechlorinating solution containing a polar aprotic solvent and water and waste plastic pyrolysis oil to form a mixed oil; a second operation of allowing the mixed oil in the first operation to stand and separating the dechlorinating solution located at a lower portion to obtain pre-treated waste plastic pyrolysis oil; a third operation of performing a dechlorination reaction by hydrotreating the pre-treated waste plastic pyrolysis oil in the second operation at a first temperature in the presence of a hydrotreating catalyst; and a fourth operation of performing a denitrification reaction by hydrotreating a product produced in the third operation at a second temperature in the presence of a hydrotreating catalyst.

Since a content of organic chlorine and a content of inorganic chlorine are reduced in the waste plastic pyrolysis oil pre-treated by the dechlorinating solution containing a polar aprotic solvent and water, in a case where the pre-treated pyrolysis oil is introduced as a raw material for a hydrotreating process, which is a refinery process, formation of an ammonium salt (NH₄Cl) may be minimized during the hydrotreating process, such that clogging of a reactor may be prevented, and the refinery process may be stably performed for a long period of time. In addition, the hydrotreating process may be performed under milder conditions, and a reduction in reaction yield caused by performing the hydrotreating under severe conditions in the related art may be prevented, such that it is possible to achieve both minimization of impurities in the waste plastic pyrolysis oil (refined oil) and improvement of the reaction yield.

In addition, in the refining method including the first operation to the fourth operation, the operations are consecutively performed, but a content of impurities in the waste plastic pyrolysis oil is first reduced in the pre-treatment processes in the first operation and the second operation, chlorine is mainly removed by performing the hydrotreating in the third operation at the first temperature, and then nitrogen is mainly removed by performing the hydrotreating in the fourth operation at the second temperature, such that chlorine and nitrogen are removed in different processes. As a result, the effect of suppressing formation of an ammonium salt (NH₄Cl) may be maximized, and it is possible to obtain high-quality waste plastic pyrolysis oil in which chlorine and nitrogen are minimized to a level of a few ppm.

Specifically, the waste plastic pyrolysis oil may be a mixture of hydrocarbon oils produced by pyrolyzing waste plastics at a high temperature. In this case, the waste plastics may include solid or liquid waste related to synthetic polymer compounds such as waste synthetic resins, waste synthetic fibers, waste synthetic rubber, and waste vinyl.

The mixture of hydrocarbon oils present in the waste plastic pyrolysis oil may include H-Naphtha (to C8, bp<150° C.):Kero (C9 to C17, bp 150 to 265° C.), LGO (C18 to C20, bp 265 to 340° C.), and VGO/AR (from C21, bp>340° C.) at a weight ratio of 10:90 to 40:60 or 20:80 to 30:70, but this is merely an example, and the composition of the waste plastic pyrolysis oil is not limited thereto. The mixture of hydrocarbon oils may be variously present within the range of 100 wt % of the composition.

The waste plastic pyrolysis oil may contain various impurities in addition to the hydrocarbon oil. For example, the waste plastic pyrolysis oil may contain impurities such as a chlorine compound, a nitrogen compound, and a metal compound, and specifically, may contain 300 ppm or more of nitrogen, 30 ppm or more of chlorine, 20 vol % or more of olefins, and 1 vol % or more of conjugated diolefins.

As for the chlorine component among the impurities, a content of the chlorine compound in the waste plastic pyrolysis oil may be 100 ppm or more, and specifically, may be 300 ppm or more, and an upper limit of the content of the chlorine compound is not particularly limited, but may be, for example, 1,000 ppm or less, and specifically, 800 ppm or less.

The chlorine compound may contain both organic chlorine and inorganic chlorine. A weight ratio of the organic chlorine and the inorganic chlorine contained in the chlorine compound may be 50:50 to 90:10, and specifically, may be 55:45 to 80:20, but this is merely an example, and the weight ratio is not limited thereto. The organic chlorine and the inorganic chlorine may be present in various ranges depending on the composition of the waste plastics.

The pre-treatment process for reducing the impurities in the waste plastic pyrolysis oil may be performed through the first operation of mixing a dechlorinating solution containing a polar aprotic solvent and water and waste plastic pyrolysis oil to form a mixed oil; and the second operation of allowing the mixed oil in the first operation to stand and separating the dechlorinating solution located at a lower portion to obtain pre-treated waste plastic pyrolysis oil. The organic chlorine and the inorganic chlorine may be simultaneously removed by using a cosolvent containing a polar aprotic solvent and water as the dechlorinating solution. Specifically, the polar aprotic solvent may effectively trap organic chlorine because it is easy to stir and remove organic polar substances, and water may effectively trap inorganic chlorine because it has high selectivity for inorganic chlorine such as HCl. The organic chlorine and the inorganic chlorine may be simultaneously and effectively removed in a single-operation process by using the dechlorinating solution.

In an embodiment, in the first operation, the dechlorinating solution and the waste plastic pyrolysis oil may be stirred at a temperature of 60 to 300° C. The waste plastic pyrolysis oil is present in a solid state at room temperature, and thus the waste plastic pyrolysis oil and the dechlorinating solution may be easily mixed within the above range, and recombination of the chlorine compound desorbed from the waste plastic pyrolysis oil with olefins may be effectively suppressed. The higher the temperature, the higher the chlorine reduction activity, but considering side reactions such as deactivation of the catalyst and cracking, it may be preferable to perform the first operation at a temperature of 300° C. or lower. Specifically, the temperature may be 60 to 270° C., and more specifically, may be 80 to 250° C.

The stirring may be performed at a stirring speed of 50 to 5,000 rpm and atmospheric pressure for 2 to 6 hours. The stirring conditions may be appropriately changed at a level that may facilitate the mixing of the dechlorinating solution and the waste plastic pyrolysis oil, and specifically, the stirring may be performed at 100 to 4,000 rpm for 3 to 5 hours but is the embodiments are not limited thereto.

Through the second operation of allowing the mixed oil in the first operation to stand and separating the dechlorinating solution located at the lower portion to obtain pre-treated waste plastic pyrolysis oil, it is possible to obtain waste plastic pyrolysis oil from which organic chlorine and inorganic chlorine are removed. Specifically, when the stirring process is completed, layer separation of the pyrolysis oil and the dechlorinating solution is started, and the mixed oil may be allowed to stand for a certain period of time for complete layer separation. The standing time may be 0.3 to 12 hours, and specifically, may be 1 hour to 10 hours. After standing, the dechlorinating solution containing organic chlorine and inorganic chlorine layered at the lower portion may be separated and removed to obtain pre-treated waste plastic pyrolysis oil.

In an embodiment, the polar aprotic solvent may have a dielectric constant of 20 or more and a density of 0.9 g/cc or more. When the dielectric constant is 20 or more, ionic compounds may be effectively separated, which may be preferable, and when the density is 0.9 g/cc or more, a ratio of the polar aprotic solvent remaining in the waste plastic pyrolysis oil is low, such that the layer separation of the dechlorinating solution may be easily performed, which may be preferable. Specifically, the dielectric constant may be 25 or more, and the density may be 0.95 g/cc or more. More specifically, the dielectric constant may be 25 to 70, and the density may be 1 to 2 g/cc.

A boiling point of the polar aprotic solvent may be 100° C. or higher. The polar aprotic solvent should be stirred with the waste plastic pyrolysis oil in a liquid state and considering a temperature condition in the first operation (mixing), it may be advantageous to use a polar aprotic solvent having a boiling point of 100° C. or higher. Specifically, the boiling point may be 120° C. or higher, and more specifically, may be 150 to 300° C.

In an embodiment, the polar aprotic solvent may contain, for example, dimethylformamide (DMF), dimethyl sulfoxide (DMSO), acetonitrile, ethyl acetate, tetrahydrofuran (THF), acetone, or the like. Considering the dielectric constant, density, and boiling point properties, and the chlorine reduction efficiency and layer separation efficiency from the waste plastic pyrolysis oil, the polar aprotic solvent may be preferably dimethylformamide (DMF) or dimethyl sulfoxide (DMSO).

In an embodiment, a difference in density between the dechlorinating solution and the waste plastic pyrolysis oil may be 0.3 g/cc or more. When the density difference is 0.3 g/cc or more, the layer separation from the pyrolysis oil may be easily performed after the second operation (standing), which may be preferable. Specifically, the density difference may be 0.4 g/cc or more, and more specifically, may be 0.5 to 2 g/cc.

In an embodiment, the dechlorinating solution may be contained in an amount of 0.1 to 20 parts by weight based on 100 parts by weight of the waste plastic pyrolysis oil. When the above parts by weight are satisfied, organic chlorine and inorganic chlorine in the waste plastic pyrolysis oil may be effectively trapped. Specifically, the dechlorinating solution may be contained in an amount of 5 to 20 parts by weight, and more specifically, 5 to 15 parts by weight, based on 100 parts by weight of the pyrolysis oil.

In an embodiment, a weight ratio of the polar aprotic solvent to the water may be 50:50 to 95:5. When the above weight ratio is satisfied, a layer separation recovery rate may be excellent, and the issue of generation of impurities due to mixing with the pyrolysis oil may be minimized. Specifically, the weight ratio may be 60:40 to 90:10, and more specifically, may be 65:35 to 85:15.

In an embodiment, the method may further include a fifth operation of separating the polar aprotic solvent from the dechlorinating solution separated in the second operation and resupplying the separated polar aprotic solvent to the first operation. Specifically, the dechlorinating solution separated in the second operation contains a polar aprotic solvent containing organic chlorine and water containing inorganic chlorine. As the polar aprotic solvent is separated and recovered from the dechlorinating solution and the separated and recovered polar aprotic solvent is resupplied to the first operation, the use amount of the polar aprotic solvent that is additionally introduced is reduced, which may improve the process efficiency, and the cost of disposing and treating by-products of the refinery process is reduced, which may improve the cost-effectiveness.

In an embodiment, the fifth operation may include a 5-1st operation of distilling the dechlorinating solution to separate the water and recovering a residual solution; a 5-2nd operation of filtering the residual solution to separate a chlorine-containing salt from the residual solution and recovering the polar aprotic solvent; and a 5-3rd operation of resupplying the recovered polar aprotic solvent as the polar aprotic solvent in the first operation.

Specifically, the 5-1st operation is an operation of distilling the dechlorinating solution, and the dechlorinating solution may contain a polar aprotic solvent containing organic chlorine and water containing inorganic chlorine. The water may be discharged and removed from the dechlorinating solution through distillation using a difference in boiling point between the water and the polar aprotic solvent, and as an example, the distillation may be performed at a temperature of 100 to 120° C. and atmospheric pressure. The residual solution may be recovered by discharging the water as water vapor through the distillation process.

The 5-2nd operation is an operation of filtering the residual solution, and the chlorine-containing salt may be separated from the residual solution. Chlorine and other impurities are present in the solution in the form of a solid salt, and thus a solid salt may be separated from the residual solution by filtering the solution. The residual solution from which the solid salt is removed may contain a polar aprotic solvent, and a small amount of residual salt such as chlorine may be present. An additional distillation process may be performed to remove the small amount of residual salt. To prevent an abnormal operation due to the small amount of residual salt such as chlorine, a content of chlorine in the polar aprotic solvent of the residual solution may be preferably 5 wt % or less, and specifically, the content of chlorine may be 1 wt % or less.

The 5-3rd operation is an operation of resupplying the recovered polar aprotic solvent as the polar aprotic solvent in the first operation. The polar aprotic solvent is recovered through the 5-1st operation to the 5-3rd operation, and the recovered polar aprotic solvent is resupplied as the polar aprotic solvent in the first operation, such that the use amount of the polar aprotic solvent that is additionally introduced is reduced, which may improve the process efficiency, and the cost of disposing and treating by-products of the refinery process is reduced, which may improve the cost-effectiveness.

Through the third operation of performing the dechlorination reaction by hydrotreating the pre-treated waste plastic pyrolysis oil at the first temperature in the presence of the hydrotreating catalyst; and the fourth operation of performing the denitrification reaction by hydrotreating the product produced in the third operation at the second temperature in the presence of the hydrotreating catalyst, it is possible to obtain waste plastic pyrolysis oil (refined oil) in which impurities such as chlorine and nitrogen are minimized.

As described above, as the waste plastic pyrolysis oil pre-treated by the dechlorinating solution containing a polar aprotic solvent and water is introduced as a raw material of the hydrotreating process in the third operation, prevention of clogging of the reactor and improvement of operational stability are achieved according to minimization of the formation and accumulation of an ammonium salt (NH₄Cl), such that a refinery device may be stably operated for a long period of time, and in addition, as the hydrotreating process is performed under mild conditions, waste plastic pyrolysis oil (refined oil) may be obtained with a high yield without deactivation of the catalyst and a change or decrease in molecular weight distribution. In addition to the above effects, chlorine is first removed in the third operation and then nitrogen is mainly removed in the fourth operation, such that the effect of minimizing formation and accumulation of an ammonium salt (NH₄Cl) in the reactor may be maximized, and the operational stability may be further improved.

The hydrotreating in the third operation and the hydrotreating in the fourth operation may be consecutively performed, and the second temperature may be a temperature higher than the first temperature. The type of each component removed in the hydrotreating in each of the third operation and the fourth operation may be determined by the reaction temperature, the hydrotreating in the third operation may be performed at the first temperature to mainly remove chlorine, and the hydrotreating in the fourth operation may be performed at the second temperature higher than the first temperature to mainly remove nitrogen.

Specifically, the hydrotreating in the third operation is performed at the first temperature, such that chlorine may be mainly removed from the waste plastic pyrolysis oil, and some olefins and metal impurities may also be removed. Hydrogenation of the waste plastic pyrolysis oil occurs in the presence of the hydrotreating catalyst, and hydrogen chloride is produced as most chlorine is removed from the waste plastic pyrolysis oil. In addition, some olefins are removed from the waste plastic pyrolysis oil, and other metal impurities are removed. A fluid containing the hydrotreated hydrocarbon oil, hydrogen chloride, and unreacted hydrogen is produced.

The hydrotreating in the fourth operation is performed at the second temperature, such that waste plastic pyrolysis oil (refined oil) obtained by removing nitrogen from the fluid may be produced. At the second temperature, all impurities including nitrogen, oxygen, and sulfur may be removed together with hydrogen chloride and unreacted hydrogen gas in the fluid, and a mixed gas containing hydrogen chloride, ammonia, water vapor, hydrogen sulfide, and the like may be produced. The mixed gas may be discharged and removed, and the waste plastic pyrolysis oil (refined oil) may be recovered through gas-liquid separation.

In an embodiment, the first temperature may be 100 to 300° C., and the second temperature may be 300 to 450° C. When the hydrotreating is performed in the first temperature range, chlorine may be intensively removed, and olefins and other metal impurities may also be effectively removed. When the hydrotreating is performed in the second temperature range, nitrogen may be intensively removed, and other impurities such as chlorine, sulfur, and oxygen may also be removed. The first temperature may be 120 to 250° C., and more specifically, 150 to 230° C., and the second temperature may be specifically 350 to 420° C., and more specifically, 370 to 400° C. A difference between the first temperature and the second temperature may be 50 to 350° C., specifically, 50 to 280° C., and more specifically, 50 to 200° C., but this is merely an example, and the difference between the first temperature and the second temperature is not limited thereto.

As the waste plastic pyrolysis oil pre-treated by the dechlorinating solution is introduced as a raw material for the hydrotreating process, the hydrotreating process is performed under slightly mild temperature conditions satisfying the first and second temperature ranges, such that waste plastic pyrolysis oil (refined oil) may be obtained with a high yield without a yield loss due to deactivation of the catalyst and a change or decrease in molecular weight distribution. Specifically, it is possible to obtain waste plastic pyrolysis oil (refined oil) with a yield of 90% or more, and more specifically, the yield may be 95% or more.

In an embodiment, the hydrotreating catalyst in each of the third operation and the fourth operation may be a catalyst in which an active metal including one or two or more selected from molybdenum, nickel, cobalt, and tungsten is supported on a support. The hydrotreating catalyst is a catalyst by which a dechlorination reaction or a denitrification reaction is performed as a main reaction depending on conditions such as the temperature described above and may contain an active metal having a hydrotreating catalytic ability. The hydrotreating catalyst may be a catalyst in which an active metal is supported on a support. The active metal may include one or two or more selected from molybdenum, nickel, cobalt, and tungsten having a hydrotreating catalytic ability. As the support, any support may be used as long as it has durability enough to support an active metal, and for example, the support may include one or two or more selected from a metal including one or two or more selected from silicon, alumina, zircon, and titanium; an oxide of the metal; and a carbon-based material including one or two or more selected from carbon black, activated carbon, graphene, a carbon nanotube, and graphite. Specifically, in an embodiment, the hydrotreating catalyst may be a catalyst in which an active metal containing 0.1 to 10 wt % of nickel and 0.1 to 30 wt % of molybdenum with respect to a total weight of the hydrotreating catalyst is supported on an alumina support. However, this is merely an example, and the hydrotreating catalyst is not limited thereto.

In an embodiment, a reaction pressure in the hydrotreating in each of the third operation and the fourth operation may be less than 100 bar. Under a high pressure condition of 100 bar or more, formation of an ammonium salt (NH₄Cl) is promoted, and under a condition in which a pressure is too low, impurities including chlorine and nitrogen may not be effectively removed. Specifically, the reaction pressure may be 30 bar to 90 bar, and more specifically, may be 50 bar to 80 bar.

In an embodiment, a ratio of liquid hourly space velocities (LHSVs) in the hydrotreating in the third operation and the hydrotreating in the fourth operation may be 1:0.1 to 1:0.8. When the above range is satisfied, the impurities may be effectively removed by the hydrotreating in each of the third operation and the fourth operation, the activity of the hydrotreating catalyst may be maintained at high activity for a long period of time, and the process efficiency may also be improved.

The waste plastic pyrolysis oil (refined oil) finally obtained by the method for refining waste plastic pyrolysis oil may be high-quality pyrolysis oil having an extremely low content of impurities. Specifically, the impurities contained in the obtained waste plastic pyrolysis oil (refined oil) may include 10 ppm (weight) or less of chlorine, 30 ppm (weight) or less of nitrogen, 10 ppm (weight) or less of sulfur, 10 ppm (weight) or less of other metal components, 0.1 wt % or less of oxygen, 10 vol % or less of olefins, and 0.2 vol % or less of conjugated diolefins.

In an embodiment, the method may further include, between the third operation and the fourth operation, an operation of performing a dechlorination process by mixing the product produced in the third operation and a dechlorinating solution containing a polar aprotic solvent and water. Since the dechlorinating solution of the present disclosure has an ability to remove both organic chlorine and inorganic chlorine, chlorine is further removed by adding the dechlorinating solution between the third operation and the fourth operation, which are the hydrotreating processes, such that the efficiency of the refinery process may be further improved. After the dechlorinating solution is added to the fluid hydrotreated in the third operation, the dechlorination process may be performed in the same manner as those in the first operation and the second operation.

In addition, the embodiments of the present disclosure provide a device for refining waste plastic pyrolysis oil, the device including a first reactor into which a dechlorinating solution containing a polar aprotic solvent and water and waste plastic pyrolysis oil are introduced and in which a pre-treatment process is performed; a second reactor into which a product produced in the first reactor and hydrogen gas are introduced and in which a dechlorination reaction is performed by hydrotreating the product at a first temperature in the presence of a hydrotreating catalyst; and a third reactor into which a product produced in the second reactor and hydrogen gas are introduced and in which a denitrification reaction is performed by hydrotreating the product at a second temperature in the presence of a hydrotreating catalyst.

Each of the reactors may be connected by a pipe, and a reaction product may be introduced from each of the reactors through the pipe.

In an embodiment, the first reactor may be a batch reactor. The first reactor may be any type of batch reactor capable of performing stirring and controlling temperature rise. A stirrer for stirring the dechlorinating solution and the waste plastic pyrolysis oil may be provided in the first reactor. The stirrer may be a stirrer having a stirring ability of 50 to 5,000 rpm.

The first reactor may be provided with an outlet at the bottom thereof. When the stirring process of the dechlorinating solution and the waste plastic pyrolysis oil is completed, layer separation is started due to a difference in density therebetween, and the mixed oil may be allowed to stand for a certain period of time for complete layer separation. The layer-separated dechlorinating solution is separated and discharged through the outlet located at the bottom of the first reactor, and the pre-treated waste plastic pyrolysis oil may be introduced into the second reactor through the pipe.

The outlet included in the first reactor may further include a density profiler, and through density detection, it is possible to prevent the pyrolysis oil layer from being removed together with the dechlorinating solution when the dechlorinating solution is removed.

In an embodiment, the second reactor and the third reactor may be fixed bed reactors. The fixed bed reactor has an advantage of high productivity and may be operated in a continuous mode.

A reaction zone provided with a hydrotreating catalyst exists in the second reactor. The pre-treated waste plastic pyrolysis oil and hydrogen gas are introduced into the reaction zone from the first reactor and the pre-treated waste plastic pyrolysis oil is hydrotreated at the first temperature, such that chlorine may be mainly removed from the waste plastic pyrolysis oil, and some olefins and metal impurities may be removed together with the chlorine.

The second reactor may not have an additional gas outlet, and accordingly, a fluid containing dechlorinated oil, which is a product produced in the second reactor, hydrogen chloride, and unreacted hydrogen may be introduced into the third reactor as it is.

A reaction zone provided with a hydrotreating catalyst exists in the third reactor. The fluid and hydrogen gas are introduced into the reaction zone from the second reactor, and hydrotreating is performed at the second temperature, such that impurities may be removed from the fluid.

The third reactor may be provided with a gas outlet through which a mixed gas is discharged at an upper portion of the third reaction zone and may be provided with an oil outlet through which waste plastic pyrolysis oil (refined oil) from which impurities are removed is discharged at a lower portion of the third reaction zone. The mixed gas may be discharged through the gas outlet, and waste plastic pyrolysis oil (refined oil) from which impurities are removed may be finally obtained through the oil outlet located at the bottom of the third reactor.

In an embodiment, the device may further include a recovery tank that recovers the dechlorinating solution discharged from the first reactor and includes a distillation zone and a filtration zone; and a recirculation line that resupplies the polar aprotic solvent separated from the recovery tank to the first reactor.

The recovery tank may include a distillation zone and a filtration zone, and the recovery tank may include a gas outlet in the distillation zone. Water may be distilled from the dechlorinating solution and discharged in the form of water vapor through the gas outlet, and the residual solution may be introduced into the filtration zone. The filtration zone may include a filtration membrane, a solid salt contained in the oil may be removed through the filtration membrane, and a small amount of residual salt may be removed by an additional distillation process.

That is, the polar aprotic solvent may be recovered by filtering a chlorine-containing salt from the residual solution through the filtration zone. The polar aprotic solvent may be resupplied to the first reactor through the recirculation line located at the bottom of the recovery tank.

As for contents not further described in the device for refining waste plastic pyrolysis oil, the description of the method for refining waste plastic pyrolysis oil described above may be used as reference.

Hereinafter, the embodiments of the present disclosure will be described in detail with reference to Examples. However, these Examples are intended to describe the embodiments of the present disclosure in more detail, and the scope of the present disclosure is not limited by the following Examples.

### Example 1

Waste plastics were pyrolyzed to prepare 500 g of a pyrolysis oil raw material.

The content (ppm) of each of total chlorine, organic chlorine, and inorganic chlorine in the waste plastic pyrolysis oil raw material was measured through ICP and XRF analysis, and it was confirmed that the content of total chlorine, the content of organic chlorine, and the content of inorganic chlorine were 860 ppm, 596 ppm, and 264 ppm, respectively.

80 g of dimethyl sulfoxide (DMSO) and 20 g of water were mixed to prepare 100 g of a dechlorinating solution.

500 g of the waste plastic pyrolysis oil and 100 g of the dechlorinating solution were put into a first reactor, and then the mixture was stirred, thereby preparing a mixed oil. Specifically, the mixture was stirred at 80° C. and 500 rpm for 3 hours, and after stirring was completed, the mixture was allowed to stand for 3 hours while maintaining the temperature as it was. Thereafter, only the layer-separated dechlorinating solution at the lower portion of the mixed oil was separated and discharged through an outlet located at the bottom of the reactor, thereby obtaining pre-treated waste plastic pyrolysis oil.

The pre-treated waste plastic pyrolysis oil was introduced into a second reactor, and then the pre-treated waste plastic pyrolysis oil was hydrotreated. Specifically, NiMo/r-Al₂O₃ and CoMo/r-Al₂O₃ as hydrotreating catalysts were provided inside the second reactor, the pre-treated waste plastic pyrolysis oil and hydrogen gas were introduced into the second reactor, and the waste plastic pyrolysis oil was hydrotreated under conditions of 250° C., 80 bar, a H2/Oil ratio of 840, and LHSV of 0.4 h⁻¹.

The fluid hydrotreated in the second reactor was introduced into a third reactor, and then the fluid was hydrotreated. Specifically, the same hydrotreating catalysts as those in the second reactor was provided inside the third reactor, each of the fluid and hydrogen gas was introduced into the third reactor, and the fluid was hydrotreated under conditions of 370° C., 85 bar, a H2/Oil ratio of 840, and LHSV of 0.7 h⁻¹.

A mixed gas containing ammonia, hydrogen chloride, water, hydrogen sulfide, hydrogen, and the like generated during the hydrotreating process was discharged through a gas outlet located at the top of the third reactor, and waste plastic pyrolysis oil (refined oil) from which impurities were removed was finally recovered through an oil outlet located at the bottom of the third reactor.

### Example 2

Waste plastic pyrolysis oil (refined oil) from which impurities were removed was recovered by performing a process in the same manner as that of Example 1, except that the refinery process was performed using 80 g of dimethylformamide (DMF) and 20 g of water as the dechlorinating solution, and setting the reaction condition of the first reactor to 120° C.

### Example 3

Waste plastic pyrolysis oil (refined oil) from which impurities were removed was recovered by performing a process in the same manner as that of Example 1, except that the refinery process was performed using 70 g of DMSO and 30 g of water as the dechlorinating solution.

### Example 4

Waste plastic pyrolysis oil (refined oil) from which impurities were removed was recovered by performing a process in the same manner as that of Example 1, except that the refinery process was performed under conditions in which the second reactor was operated at 160° C. and 85 bar and the third reactor was operated at 320° C. and 90 bar.

### Example 5

Waste plastic pyrolysis oil (refined oil) from which impurities were removed was recovered by performing a process in the same manner as that of Example 1, except that the refinery process was performed using 80 g of tetrahydrofuran (THF) instead of DMSO and 20 g of water as the dechlorinating solution.

### Example 6

Waste plastic pyrolysis oil (refined oil) from which impurities were removed was recovered by performing a process in the same manner as that of Example 1, except that the refinery process was performed using 30 g of DMSO and 70 g of water as the dechlorinating solution.

### Comparative Example 1

Waste plastic pyrolysis oil (refined oil) from which impurities were removed was recovered by performing a process in the same manner as that of Example 1, except that the refinery process was performed by directly introducing the waste plastic pyrolysis oil into the second reactor without the first reactor.

### Comparative Example 2

Waste plastic pyrolysis oil (refined oil) from which impurities were removed was recovered by performing a process in the same manner as that of Example 1, except that the refinery process was performed using only 100 g of DMSO as the dechlorinating solution.

### Comparative Example 3

Waste plastic pyrolysis oil (refined oil) from which impurities were removed was recovered by performing a process in the same manner as that of Example 1, except that the refinery process was performed using only 100 g of water as the dechlorinating solution.

### Comparative Example 4

Waste plastic pyrolysis oil (refined oil) from which impurities were removed was recovered by performing a process in the same manner as that of Example 1, except that the refinery process was performed by setting the reaction conditions of the second reactor to be the same as those of the third reactor.

### Result Measurement Method

### Chlorine Content

The content (ppm) of each of the total chlorine, organic chlorine, and inorganic chlorine in the obtained waste plastic pyrolysis oil was measured through ICP and XRF analysis.

### Maximum Operation Time

The maximum operation time required until a pressure loss (delta P) due to an ammonium salt (NH₄Cl) produced during the hydrotreating process reached 7 bar was measured.

TABLE 1

| | | Exam- | Exam- | Exam- | Exam- | Exam- | Exam- | Comparative | Comparative | Comparative | Comparative |
|---|---|---|---|---|---|---|---|---|---|---|---|
| | | ple 1 | ple 2 | ple 3 | ple 4 | ple 5 | ple 6 | Example 1 | Example 2 | Example 3 | Example 4 |
| First | Solvent | DMSC | DMF | DMSO | DMSO | 80 | DMSO | — | DMSO | — | DMSO |
| reactor | (g) | 30 | 80 | 70 | 80 | | 30 | | 100 | | 80 |
| | Water | 20 | 20 | 30 | 20 | 20 | 70 | — | — | 100 | 20 |
| | (g) | | | | | | | | | | |
| | Temperature | 30 | 120 | 80 | 80 | 80 | 80 | 80 | 80 | 80 | 80 |
| | (° C.) | | | | | | | | | | |
| Second | Temperature | 250 | 250 | 250 | 160 | 250 | 250 | 250 | 250 | 250 | 370 |
| reactor | (° C.) | | | | | | | | | | |
| | Pressure | 80 | 80 | 80 | 85 | 30 | 80 | 80 | 80 | 80 | 85 |
| | (bar) | | | | | | | | | | |
| Third | Temperature | 370 | 370 | 370 | 320 | 370 | 370 | 370 | 370 | 370 | 370 |
| reactor | (° C.) | | | | | | | | | | |
| | Pressure | 85 | 85 | 85 | 90 | 85 | 85 | 85 | 85 | 85 | 85 |
| | (bar) | | | | | | | | | | |

| | | | | | | | | | | |
|---|---|---|---|---|---|---|---|---|---|---|
| Organic chlorine₀ | 124 | 132 | 135 | 126 | 279 | 321 | 596 | 124 | 567 | 124 |
| (ppm) | | | | | | | | | | |
| Inorganic chlorine₀ | 67 | 72 | 55 | 65 | 85 | 35 | 264 | 237 | 69 | 67 |
| (ppm) | | | | | | | | | | |
| Organic chlorine₁ | <1 | <1 | <2 | <1 | <10 | <10 | <20 | <1 | <20 | <1 |
| (ppm) | | | | | | | | | | |
| Inorganic chlorine₁ | <1 | <1 | <1 | <1 | <1 | <1 | <1 | <1 | <1 | <1 |
| (ppm) | | | | | | | | | | |
| Maximum operation | >17 | >16 | >15 | >17 | <9 | <9 | <5 | <7 | <7 | <5 |
| time (day) | | | | | | | | | | |

Organic chlorine₀: Content of organic chlorine in waste plastic pyrolysis oil pre-treated through first reactor
Inorganic chlorine₀: Content of inorganic chlorine in waste plastic pyrolysis oil pre-treated through first reactor
Organic chlorine₁: Content of organic chlorine in waste plastic pyrolysis oil obtained after hydrotreating in third reactor
Inorganic chlorine₁: Content of inorganic chlorine in waste plastic pyrolysis oil obtained after hydrotreating in third reactor

### Evaluation

In the cases of Examples 1, 3, and 4, it could be confirmed that as the waste plastic pyrolysis oil was pre-treated in the first reactor with the dechlorinating solution containing a polar aprotic solvent DMSO having a dielectric constant of 47 and a density of 1.1 and water, the content of organic chlorine; and the content of inorganic chlorine₀ were effectively reduced to 150 ppm or less and 80 ppm or less, respectively. In addition, also in Example 2, it could be confirmed that in the pyrolysis oil pre-treated in the first reactor with the dechlorinating solution containing DMF having a dielectric constant of 38 and a density of 0.94 as a polar aprotic solvent and water, the content of organic chlorine; and the content of inorganic chlorine were effectively reduced to 150 ppm or less and 80 ppm or less, respectively. Accordingly, it was confirmed that the hydrotreating process, which was a continuous process, was stably performed for a long period of time of 15 days or longer, and it could be confirmed that the content of organic chlorine₀ in the finally obtained pyrolysis oil (refined oil) was reduced to a level of a few ppm.

In particular, through Example 4, it could be confirmed that as the contents of organic chlorine₀ and inorganic chlorine₀ in the pyrolysis oil were reduced in the first reactor, even when the hydrotreating process was performed under slightly mild conditions of the temperature of the second reactor of 160° C. and the temperature of the third reactor of 320° C., the contents of organic chlorine₁ and inorganic chlorine₁ in the finally obtained pyrolysis oil (refined oil) were effectively reduced to a level of a few ppm.

On the other hand, in the case of Example 5, as THE (the dielectric constant of 7.5 and the density of 0.89) was used as a polar aprotic solvent in the first reactor, the content of organic chlorine₀ and the content of inorganic chlorine₀ in the pre-treated pyrolysis oil were 279 ppm and 85 ppm, respectively, and it could be confirmed that the chlorine removal effect was slightly reduced compared to those in Examples 1 to 4, but was superior to those in Comparative Examples 1 and 3.

Also, in the case of Example 6, as an excessive amount of water relative to DMSO, which was a polar aprotic solvent, was contained in the dechlorinating solution, the content of organic chlorine₀ and the content of inorganic chlorine₀ in the pre-treated pyrolysis oil were 321 ppm and 35 ppm, respectively, and it could be confirmed that the organic chlorine removal effect was slightly reduced compared to those in Examples 1 to 4, but was superior to those in Comparative Examples 1 and 3. In addition, as the content of chlorine in the pyrolysis oil was increased, it could be confirmed that the maximum operation time of the hydrotreating process, which was a continuous process, was shortened to 9 days or shorter, and it could be confirmed that the content of organic chlorine₁ in the finally obtained pyrolysis oil (refined oil) was a level of about 10 ppm, which was slightly high.

In Comparative Example 1, as the pre-treatment process through the first reactor was not performed, it could be confirmed that the maximum operation time of the hydrotreating process was significantly shortened to 5 days or shorter, and the content of organic chlorine₁ in the finally obtained pyrolysis oil (refined oil) was a level of 20 ppm, which was high.

In Comparative Example 2, as DMSO was used alone as the dechlorinating solution, the content of inorganic chlorine₀ in the pre-treated pyrolysis oil was 237 ppm, and it could be confirmed that the inorganic chlorine reduction efficiency was reduced.

In Comparative Example 3, as water was used alone as the dechlorinating solution, the content of organic chlorine₀ in the pre-treated pyrolysis oil was 569 ppm, and it could be confirmed that the organic chlorine reduction efficiency was reduced.

Accordingly, in both Comparative Examples 2 and 3, it could be confirmed that the maximum operation time in the hydrotreating process was significantly shortened to 7 days or shorter. Specifically, in Comparative Example 3, it could be confirmed that the content of organic chlorine₁ in the finally obtained pyrolysis oil (refined oil) was a level of 20 ppm, which was high.

In Comparative Example 4, as the pre-treated waste plastic pyrolysis oil was hydrotreated only under conditions of 370° C. and 85 atm in both the second reactor and the third reactor, it could be confirmed that formation of an ammonium salt (NH₄Cl) was increased, and thus the maximum operation time was significantly shortened to 5 days or shorter.

Although embodiments of the present disclosure have been described, the present invention is not limited to the embodiments, but may be prepared in various different forms, and it will be apparent to those skilled in the art to which the present disclosure pertains that the embodiments may be implemented in other specific forms without departing from the spirit or essential feature of the present invention. Therefore, it is to be understood that the embodiments described hereinabove are illustrative rather than restrictive in all aspects. Furthermore, the embodiments may be combined to form additional embodiments.

1. A method for refining waste plastic pyrolysis oil, the method comprising:
a first operation of mixing a dechlorinating solution containing a polar aprotic solvent and water and waste plastic pyrolysis oil to form a mixed oil;
a second operation of allowing the mixed oil in the first operation to stand and separating the dechlorinating solution located at a lower portion to obtain pre-treated waste plastic pyrolysis oil;
a third operation of performing a dechlorination reaction by hydrotreating the pre-treated waste plastic pyrolysis oil in the second operation at a first temperature in the presence of a hydrotreating catalyst; and
a fourth operation of performing a denitrification reaction by hydrotreating a product produced in the third operation at a second temperature in the presence of a hydrotreating catalyst.

2. The method of claim 1, wherein in the first operation, the dechlorinating solution and the waste plastic pyrolysis oil are stirred at a temperature of 60 to 300° C.

3. The method of claim 1, wherein the polar aprotic solvent has a dielectric constant of 20 or more and a density of 0.9 g/cc or more.

4. The method of claim 1, wherein the polar aprotic solvent contains dimethylformamide (DMF) or dimethyl sulfoxide (DMSO).

5. The method of claim 1, wherein a difference in density between the dechlorinating solution and the waste plastic pyrolysis oil is 0.3 g/cc or more.

6. The method of claim 1, wherein the dechlorinating solution is contained in an amount of 0.1 to 20 parts by weight based on 100 parts by weight of the waste plastic pyrolysis oil.

7. The method of claim 1, wherein a weight ratio of the polar aprotic solvent to the water is 50:50 to 95:5.

8. The method of claim 1, further comprising a fifth operation of separating the polar aprotic solvent from the dechlorinating solution separated in the second operation and resupplying the separated polar aprotic solvent to the first operation.

9. The method of claim 8, wherein the fifth operation includes:
a 5-1st operation of distilling the dechlorinating solution to separate the water and recovering a residual solution;
a 5-2nd operation of filtering the residual solution to separate a chlorine-containing salt from the residual solution and recovering the polar aprotic solvent; and
a 5-3rd operation of resupplying the recovered polar aprotic solvent as the polar aprotic solvent in the first operation.

10. The method of claim 1, wherein the first temperature is 100 to 300° C., and the second temperature is 300 to 450° C.

11. The method of claim 1, wherein the hydrotreating catalyst in each of the third operation and the fourth operation is a catalyst in which an active metal including one or two or more selected from molybdenum, nickel, cobalt, and tungsten is supported on a support.

12. The method of claim 1, wherein a reaction pressure in the hydrotreating in each of the third operation and the fourth operation is less than 100 bar.

13. The method of claim 1, wherein a ratio of liquid hourly space velocities (LHSVs) in the hydrotreating in the third operation and the hydrotreating in the fourth operation is 1:0.1 to 1:0.8.

14. The method of claim 1, further comprising, between the third operation and the fourth operation, an operation of performing a dechlorination process by mixing the product produced in the third operation and a dechlorinating solution containing a polar aprotic solvent and water.

15. A device for refining waste plastic pyrolysis oil, the device comprising:
a first reactor into which a dechlorinating solution containing a polar aprotic solvent and water and waste plastic pyrolysis oil are introduced and in which a pre-treatment process is performed;
a second reactor into which a product produced in the first reactor and hydrogen gas are introduced and in which a dechlorination reaction is performed by hydrotreating the product at a first temperature in the presence of a hydrotreating catalyst; and
a third reactor into which a product produced in the second reactor and hydrogen gas are introduced and in which a denitrification reaction is performed by hydrotreating the product at a second temperature in the presence of a hydrotreating catalyst.

16. The device of claim 15, wherein the first reactor is a batch reactor.

17. The device of claim 15, wherein the second reactor and the third reactor are fixed bed reactors.

18. The device of claim 15, further comprising:
a recovery tank that recovers the dechlorinating solution discharged from the first reactor and includes a distillation zone and a filtration zone; and
a recirculation line that resupplies the polar aprotic solvent separated from the recovery tank to the first reactor.
